(19) United States
(12) Patent Application Publication
(10) Pub. No.: US 2015/0256811 A1
(43) Pub. Date: Sep. 10, 2015

(54) METHOD AND APPARATUS FOR GENERATING THREE DIMENSIONAL IMAGE USING MONOSCOPIC CAMERA

(71) Applicant: Hyundai Motor Company, Seoul (KR)

(72) Inventors: Seok Beom LEE, Seoul (KR); Yang Shin KIM, Tongyeong-si (KR); Dong Hee SEOK, Seoul (KR)

(21) Appl. No.: 14/453,240

(22) Filed: Aug. 6, 2014

(30) Foreign Application Priority Data
Mar. 6, 2014 (KR) 10-2014-0026728

(51) Int. Cl. H04N 13/02; H04N 13/00

(52) U.S. Cl. CPC H04N 13/026; H04N 13/0007; H04N 13/0253; H04N 13/0207

(57) ABSTRACT

A method for generating a three dimensional image using a monoscopic camera, includes controlling light intensity of illumination stepwise at a plurality of light intensity steps. Subject is photographed to generate images for each of the plurality of light intensity steps using the monoscopic camera. Each of the images for each light intensity step is converted into binary images. A difference image between the converted binary images is obtained. The difference images are reconstructed to generate the three dimensional image.

### CROSS-REFERENCE TO RELATED APPLICATION

This application is based on and claims priority from Korean Patent Application No. 10-2014-0026728, filed on Mar. 6, 2014 in the Korean Intellectual Property Office, the entire contents of which are hereby incorporated by reference.

### TECHNICAL FIELD

The present inventive concept relates to a method and an apparatus for generating a three dimensional image using a monoscopic camera, and more particularly, to a method and an apparatus for generating a three dimensional image using a monoscopic camera capable of controlling light intensity of illumination and generating a three dimensional image using images photographed by the monoscopic camera.

### BACKGROUND

Since human eyes viewing an object are apart from each other by a predetermined distance, different images are formed on a left eye and a right eye. This is called a binocular disparity. Meanwhile, a human brain synthetically judges the images formed on the left and right eyes to recognize them as one image and feel a cubic effect as a three dimensional image.

The traditional way mainly acquires the three dimensional image using a stereo camera. However, in the case of using the stereo camera, a computational amount increases at the time of detecting the three dimensional image and costs increase due to an addition of a camera.

Further, a depth measurement range and a resolution of the three dimensional camera based on a traditional time of flight (TOF) type, structured light type, or the like rely on hardware, and therefore the three dimensional camera has a difficulty in measuring a driver's face from various postures of the driver.

### SUMMARY

Accordingly, the present inventive concept has been made to solve the above-mentioned problems occurring in the prior art while advantages achieved by the prior art are maintained intact.

One object to be achieved by the present inventive concept is to provide a method and an apparatus for generating a three dimensional image using a monoscopic camera capable of controlling light intensity of illumination and generating a three dimensional image using images photographed by the monoscopic camera.

One aspect of the present inventive concept relates to a method for generating a three dimensional image using a monoscopic camera, including controlling light intensity of illumination stepwise at a plurality of light intensity steps. Subject is photographed to generate images for each of the plurality of light intensity steps using the monoscopic camera. Each of the images for each light intensity step is converted into binary images. A difference image between the converted binary images is obtained. The difference images are reconstructed to generate the three dimensional image.

In the photographing of the subject, the light intensity of illumination may be increased from an initial light intensity to a maximum light intensity stepwise.

The maximum light intensity may be set to be a light intensity to capture the overall subject.

Another aspect of the present inventive concept encompasses a method for generating a three dimensional image using a monoscopic camera, including controlling light intensity of illumination stepwise at a plurality of light intensity steps. Subject is photographed to generate images for each of the light intensity steps using the monoscopic camera. A difference image between the images for each light intensity step is obtained. The difference images are reconstructed to generate the three dimensional image.

The monoscopic camera may be a binary camera.

Still another aspect of the present inventive concept relates to an apparatus for generating a three dimensional image using a monoscopic camera, including an illumination device, a monoscopic camera and a processor. The illumination device is configured to irradiate light at predetermined light intensity. The monoscopic camera is configured to photograph a subject to generate images using one lens. The processor is configured to control the light intensity stepwise at a plurality of light intensity steps, photograph the subject to generate the images for each light intensity step using the monoscopic camera, and obtain difference images between the photographed images and then reconstruct the difference images to generate the three dimensional image.

The processor may be configured to convert the images for each light intensity step into binary images and obtain the difference images between the converted binary images to acquire images for each depth.

The processor may be configured to increase the light intensity of illumination device from an initial light intensity to a maximum light intensity stepwise and photograph the subject to generate the images using the monoscopic camera.

The processor may be configured to obtain the difference images between images after and before each light intensity step.

The monoscopic camera may be a binary camera.

### BRIEF DESCRIPTION OF THE DRAWINGS

The above and other objects, features and advantages of the present inventive concept will be more apparent from the following detailed description taken in conjunction with the accompanying drawings, in which like reference characters may refer to the same or similar parts throughout the different views. The drawings are not necessarily to scale, emphasis instead being placed upon illustrating the principles of the embodiments of the inventive concept.

FIG. 1 is a block configuration diagram of an apparatus for generating a three dimensional image using a monoscopic camera according to an exemplary embodiment of the present inventive concept.

FIG. 2 is an example of converting photographed images into binary images according to an exemplary embodiment of the present inventive concept.

FIG. 3 is an example of generating a three dimensional image using a difference image according to an exemplary embodiment of the present inventive concept.

FIG. 4 is a flow chart illustrating a method for generating a three dimensional image using a monoscopic camera according to an exemplary embodiment of the present inventive concept.

### DETAILED DESCRIPTION

Hereinafter, embodiments of the present inventive concept will be described with reference to the accompanying drawings.

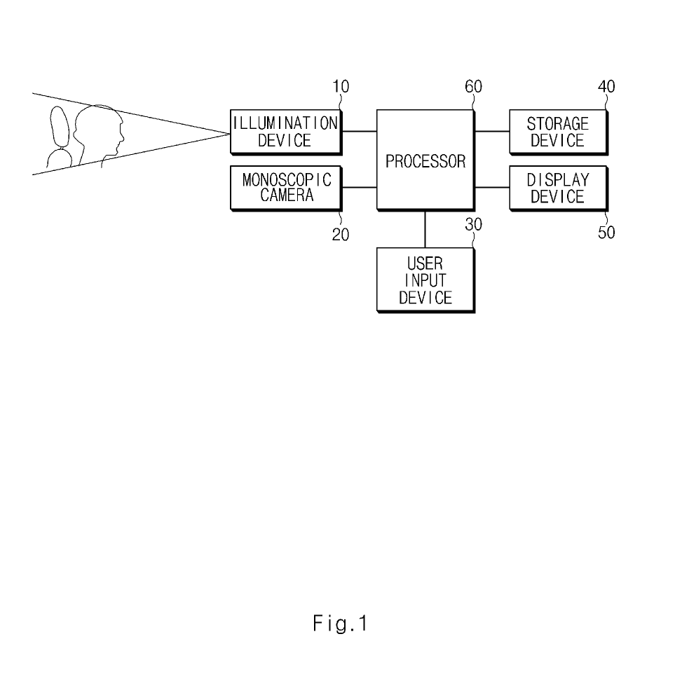

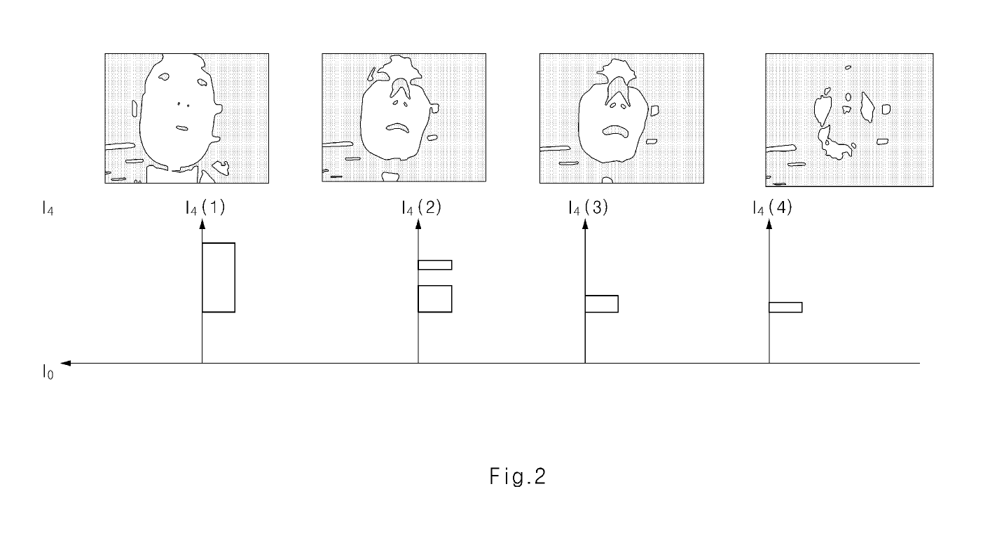

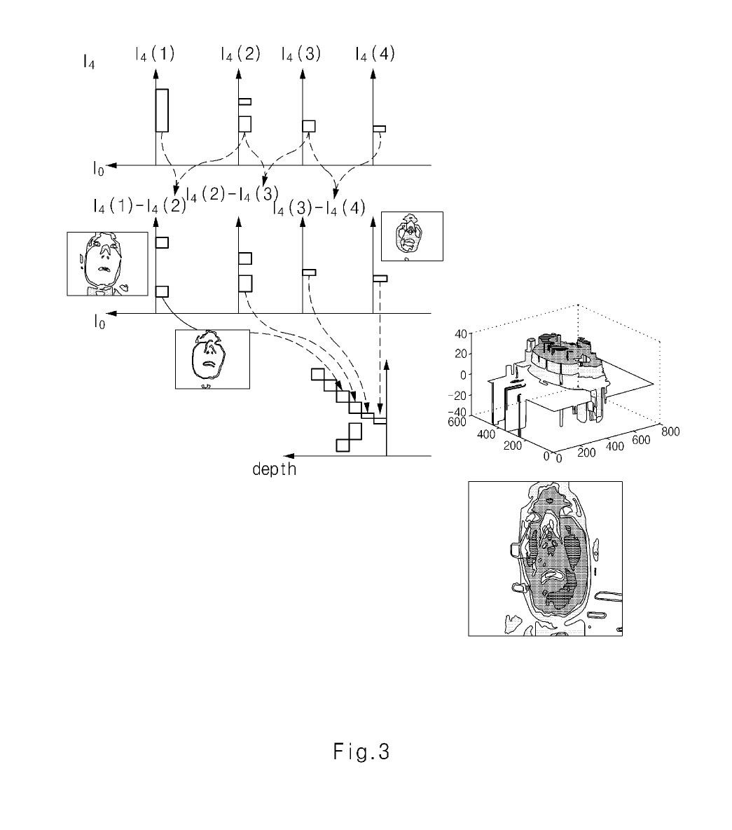

FIG. 1 is a block configuration diagram of an apparatus for generating a three dimensional image using a monoscopic camera according to an exemplary embodiment of the present inventive concept, FIG. 2 is an example of converting a photographed image into binary images according to an exemplary embodiment of the present inventive concept, and FIG. 3 is an example of generating a three dimensional image using difference images according to an exemplary embodiment of the present inventive concept.

As illustrated in FIG. 1, the apparatus for generating a three dimensional image according to an exemplary embodiment of the present inventive concept may include an illumination device 10, a monoscopic camera 20, a user input device 30, a storage device 40, a display device 50, and a processor 60.

The illumination device 10 may be a device which irradiates light to a subject (e.g., a person or an object) at predetermined light intensity and use a light emitting diode (LED), an incandescent lamp, a halogen lamp, and the like as a light source.

The light intensity I₁ which is irradiated by the illumination device 10 may be represented by the following Equation 1.

$${I}_{1} = \frac{{I}_{O}}{{r}_{i}^{2}} \qquad [ Equation 1 ]$$

In the above Equation 1, I₀ represents the light intensity of illumination and r₁ represents a distance between the illumination (e.g., the illumination device 10) and a subject (e.g., driver).

The light irradiated from the illumination device 10 may be reflected from the subject. In this case, the intensity I₂ of reflected light may be calculated by the following Equation 2.

I₂=k₂×I₁ [Equation 2]

In the above Equation 2, k₂ is a constant.

The monoscopic camera 20 may photograph (capture) the subject through one lens. The monoscopic camera 20 may represent brightness and/or color information on the photographed image by the same color space as a YCrCb color space or an RGB color space.

Light intensity I₃ acquired by the monoscopic camera 20 may be calculated by the following Equation 3. That is, the light intensity acquired by the monoscopic camera 20 may indicate the light intensity which is incident through the lens at the time of photographing an image using the monoscopic camera 20.

$${I}_{3} = {k}_{2} \times \frac{{I}_{O}}{{r}_{i}^{2}} \times \frac{1}{{r}_{O}^{2}} \qquad [ Equation 3 ]$$

In the above Equation 3, ro represents a distance between a camera (e.g., the monoscopic camera 20) and a subject (e.g., driver).

In the case of r₀=−rᵢ, the light intensity acquired by the camera has a function relation between the light intensity of illumination and the distance between the illumination and the subject as represented by the following Equation 4.

$${I}_{3} = {k}_{2} \times \frac{{I}_{O}}{{r}_{i}^{4}} \qquad [ Equation 4 ]$$

The user input device 30 may serve to receive commands and data from a user. The user input device 30 may be implemented as a type such as a keypad, a button, a touch screen, a touch pad.

The storage device 40 may store images captured by the monoscopic camera 20 and setting information.

The display device 50 may display the images inputted through the lens of the monoscopic camera 20 or display various types of data such as the photographed images. The display device 50 may output states and results according to the operation of the apparatus for generating a three dimensional image.

The processor 60, e.g., a processor having a microprocessor, may control each component as described above to control the operation of the apparatus for generating a three dimensional image. The processor 60 may set the maximum light intensity of the illumination device 10 depending on a control command inputted from the user input device 30 and control the illumination device 10 to control the light intensity stepwise. The processor 60 may increase the light intensity of the illumination device 10 from the set minimum light intensity stepwise and photograph the subject to generate at least two images using the monoscopic camera 20. In this case, the image photographed by the monoscopic camera 20 may be a two dimensional image.

The processor 60 may convert each of the images photographed by the monoscopic camera 20 into binary images. In this case, the processor 60 may convert the photographed images into the binary images based on the following Equation 5. For example, the processor 60 may represent or encode the images by 0 or 1 depending on whether the light intensity of each pixel of the images captured by the monoscopic camera 20 exceeds a threshold value.

I₄=sign (I₃−Iₜₕ) [Equation 5]

In the above Equation 5, Iₜₕ which is a threshold value may be set by software or may be set by controlling a hardware gain value of the camera.

As illustrated in FIG. 2, when the light intensity of illumination is controlled in four steps, the processor 60 may increase the light intensity by one step from the set minimum light intensity, capture each of the images having the desired resolution, and convert the captured images into the binary images.

The processor 60 may obtain a difference image J between the converted binary images for each light intensity to obtain the images corresponding to each depth. As illustrated in FIG. 3, the difference images I_{4(1)-I}₄(2), I₄(2)−I₄(3), and I₄(3)−I₄(4) between the binary images after and before the light intensity may be each obtained. The so obtained difference images may correspond to the images for each depth.

The processor 60 may reconstruct the difference images to generate the three dimensional image. That is, the processor 60 may reconstruct the difference images depending on the depth to generate the three dimensional image.

According to an embodiment of the present inventive concept, the processor 60 may convert the images photographed by the monoscopic camera 20 into the binary images and obtain the difference images between the converted binary images. However, the processor 60 can directly obtain a difference image between the images for each light intensity step without passing through the process of converting the images photographed by the monoscopic camera 20 into the binary images.

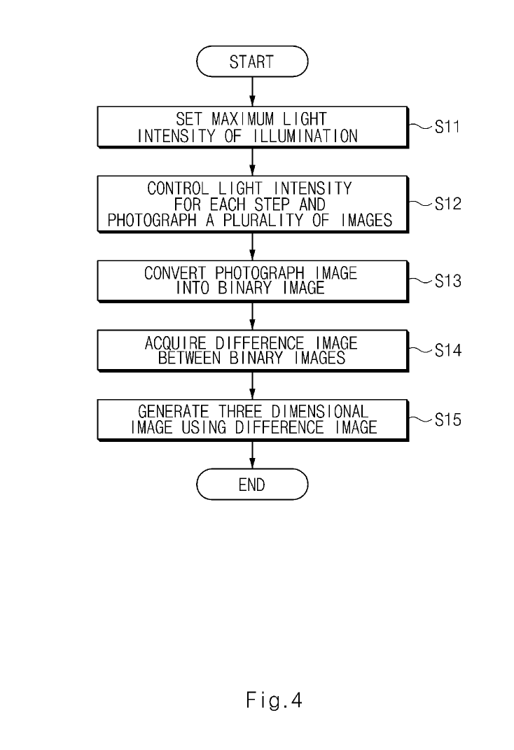

FIG. 4 is a flow chart illustrating a method for generating a three dimensional image using a monoscopic camera according to an exemplary embodiment of the present inventive concept.

First, the processor 60 of the apparatus for generating a three dimensional image may set the maximum light intensity depending on the user input inputted from the user input device 30 (S11). Here, the maximum light intensity may be the light intensity to capture the overall subject to be photographed. For example, when the subject is a driver's face, the light intensity to capture the overall driver's face may be set to be the maximum light intensity. In this case, the processor 60 may also set initial light intensity (minimum light intensity).

The processor 60 may control the light intensity of the illumination device 10 from the initial light intensity to the maximum light intensity stepwise and photograph the images for each light intensity using the monoscopic camera 20 (S12). That is, the processor 60 may increase the light intensity stepwise and capture the images for each step.

The processor 60 may convert each of the images photographed by the monoscopic camera 20 into the binary images (S13). That is, the processor 60 may convert the two dimensional images photographed by the monoscopic camera 20 into the binary images.

The processor 60 may obtain the difference images between the converted binary images for each light intensity step (S14). In this case, the processor 60 may obtain the difference images between the binary images after and before the light intensity and obtain the images for each depth.

The processor 60 may reconstruct the difference images depending on the depth to generate the three dimensional image (S15).

According to exemplary embodiments of the present inventive concept, the binary camera may be used by way of example and may be used as the monoscopic camera 20. When the binary camera is applied to the apparatus for generating a three dimensional image, the difference images between the binary images may be directly obtained without passing through the process of converting the images photographed by the camera into the binary images. Therefore, according to embodiments of the present inventive concept, the use of the binary camera can reduce the computational amount and quickly increase the processing speed.

According to embodiments of the present inventive concept, it is possible to control the light intensity of illumination and generate the three dimensional image using the images photographed by the monoscopic camera. As such, according to embodiments of the present inventive concept, the monoscopic camera may be used and therefore costs may be saved.

Further, according to embodiments of the present inventive concept, it is possible to freely set the desired depth and the desired resolution by controlling the light intensity of illumination.

Further, according to embodiments of the present inventive concept, the computational amount may be reduced at the time of using the binary camera and thus the computation speed may be fast, thereby saving costs and improving marketability.

As described above, although the present inventive concept has been described with reference to exemplary embodiments and the accompanying drawings, it would be appreciated by those skilled in the art that the present inventive concept is not limited thereto but various modifications and alterations might be made without departing from the scope defined in the following claims.

What is claimed is:

1. A method for generating a three dimensional image using a monoscopic camera, comprising:
controlling light intensity of illumination stepwise at a plurality of light intensity steps and photographing a subject to generate images for each of the plurality of light intensity steps using the monoscopic camera;
converting each of the images for each light intensity step into binary images;
obtaining a difference image between the converted binary images; and
reconstructing the difference images to generate the three dimensional image.

2. The method according to claim 1, wherein the photographing of the subject includes increasing the light intensity of illumination from an initial light intensity to a maximum light intensity stepwise.

3. The method according to claim 2, wherein the maximum light intensity is set to be a light intensity to capture the overall subject.

4. A method for generating a three dimensional image using a monoscopic camera, comprising:
controlling light intensity of illumination stepwise at a plurality of light intensity steps and photographing a subject to generate images for each of the plurality of light intensity steps using the monoscopic camera;
obtaining a difference image between the images for each light intensity step; and
reconstructing the difference images to generate the three dimensional image.

5. The method according to claim 4, wherein the monoscopic camera is a binary camera.

6. An apparatus for generating a three dimensional image using a monoscopic camera, comprising:
an illumination device configured to irradiate light at a predetermined light intensity;
a monoscopic camera configured to photograph a subject to generate images using one lens; and
a processor configured to control the light intensity stepwise at a plurality of light intensity steps, photograph the subject to generate the images for each of the plurality of light intensity steps using the monoscopic camera, and obtain difference images between the photographed images and then reconstruct the difference images to generate the three dimensional image.

7. The apparatus according to claim 6, wherein the processor is configured to convert the images for each light intensity step into binary images and obtain the difference images between the converted binary images to acquire images for each depth.

8. The apparatus according to claim 6, wherein the processor is configured to increase the light intensity of illumination device from an initial light intensity to a maximum light intensity stepwise and photograph the subject to generate the images using the monoscopic camera.

9. The apparatus according to claim 6, wherein the processor is configured to obtain the difference images between images after and before each light intensity step.

10. The apparatus according to claim 6, wherein the monoscopic camera is a binary camera.
